(19) United States
(12) Patent Application Publication
(10) Pub. No.: US 2012/0130627 A1
(43) Pub. Date: May 24, 2012

(54) TAXI DISPATCH SYSTEM

(76) Inventors: Mohammad R. Islam, Dix Hills, NY (US); Rakibul Islam, Elmhurst, NY (US)

(21) Appl. No.: 12/953,141

(22) Filed: Nov. 23, 2010

(51) Int. Cl. G06F 17/00

(52) U.S. Cl. 701/300

(57) ABSTRACT

A system, method and computer program are provided for dispatching taxis. A list of the closest, available taxis is sent to a customer. The customer selects at least one taxi in the list that is to receive a travel request. After one of the taxis has accepted the travel request, a display is provided which indicates the location of the customer and the location of a taxi which has accepted the travel request. Updated location information is periodically submitted to determine updated locations for the customer and taxi throughout the pendency of the travel request.

### BACKGROUND

1. Technical Field

The present invention relates to vehicle dispatch systems, and more particularly to an interactive vehicle dispatch system which permits customers and taxis to track each other.

2. Description of the Related Art

Traditional methods of dispatching taxis are inadequate. Customers are often required to call a taxi service to order a taxi over the phone. If the customer does not have the phone number for the taxi service, the customer has to look up the phone number in a phone directory. Even if the customer has the phone number for the taxi service, the customer is typically required to submit a pickup request to a dispatcher who must then relay the pickup request a taxi driver. This method of relaying pickup requests is inefficient and inherently includes an unnecessary delay.

Other deficiencies associated with conventional dispatch systems relate to the fact that these systems do not permit taxis and customers to track each other while the taxi is en route to pick up the customer. As a result, customers have to estimate or guess the exact arrival time of the taxi, and taxis may have difficulty determining the precise location of the customer that is to be picked up.

### SUMMARY

In accordance with the present principles, a method for dispatching taxis is disclosed. The method involves sending a list of taxis to a customer and selecting at least one taxi from the list that is to receive a travel request. A display is provided which indicates a location of the customer and a location of a taxi which has accepted the travel request. Location information of the customer and taxi is updated during pendency of the accepted travel request.

In accordance with the present principles, a system for dispatching taxis is disclosed. The system includes a communication device configured to receive a list of taxis and to permit the selection of at least one taxi in the list that is to receive a travel request. A display indicates a location of a customer and a location of a taxi which has accepted the travel request. The system further includes a server which is configured to receive updated location information for determining updated locations for the customer and taxi.

In accordance with the present principles, a computer program product for dispatching taxis is disclosed. A list of taxis is sent to a customer and at least one taxi from the list is selected to receive a travel request. A display indicates the location of the customer and the location of a taxi which has accepted the travel request. Location information is updated for the customer and taxi during pendency of the accepted travel request.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a high-level architecture for a taxi dispatch system in accordance with the present principles.

FIG. 2 is a block/flow diagram illustrating an exemplary method for providing a taxi dispatch service to a customer.

FIG. 3 is a block/flow diagram illustrating an exemplary method for providing a taxi dispatch service to a taxi.

FIG. 4 is a block/flow diagram illustrating an exemplary method for providing a taxi dispatch service.

### DETAILED DESCRIPTION OF PREFERRED EMBODIMENTS

In accordance with the present principles, an automated taxi dispatch service is provided which permits taxis and customers to schedule a travel request and to track each other during the pendency of the travel request. Taxis and customers communicate directly with each other in an organized manner without having relay information through a dispatcher or other intermediary. Moreover, neither party has to guess the exact pickup location since both parties are able to track each others' location.

As will be described in further detail below, a customer logs in and submits a travel request which is forwarded to available taxis in the vicinity. There are two distinct types of requests that can be made: a general request for hailing a cab, and a request for service to or from an airport.

When issuing a general request for a cab, the request is confirmed by one of the taxis, the customer and taxi exchange parameters. That is, a set of customer parameters (e.g., customer user ID, request details, customer coordinates) are provided to the taxi and a set of taxi parameters (e.g., taxi ID, taxi coordinates) are provided to the customer. Using these parameters, customer and taxis can determine the respective locations of each other. An interactive map, or other type of display, may be provided which allows the customer and/or taxi to view each other's respective location and to track each other throughout the pendency of the travel request. Both the customer and taxi may periodically submit their coordinates to update their location.

The airport service works slightly differently from the cab service. First, the customer must select an option which indicates whether the customer is traveling from an airport or to an airport. After selecting an address and an airport to travel between, the customer is asked to provide specific passenger information which serves to identify the customer while at the airport. From there, the customer proceeds to select a cab as previously described.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Although the description herein is provided with reference to a taxi dispatching service, the present principles are much broader in scope and can be utilized in conjunction with any type sort of service which involves dispatching a vehicle to pick up or drop off a person or item. For example, upon reading this description it will be readily apparent that the present principles can be used in conjunction with delivery services, thus allowing a delivery vehicle and customer to determine each others' location and to track each other while a package is being delivered. Likewise, the airport service is another extension of this system which can be easily implemented. Moreover, although the examples provided herein describe schemes for dispatching taxis, it should be understood that the present principles are applicable to all types of vehicles (e.g., cars, trucks, planes, boats, etc.).

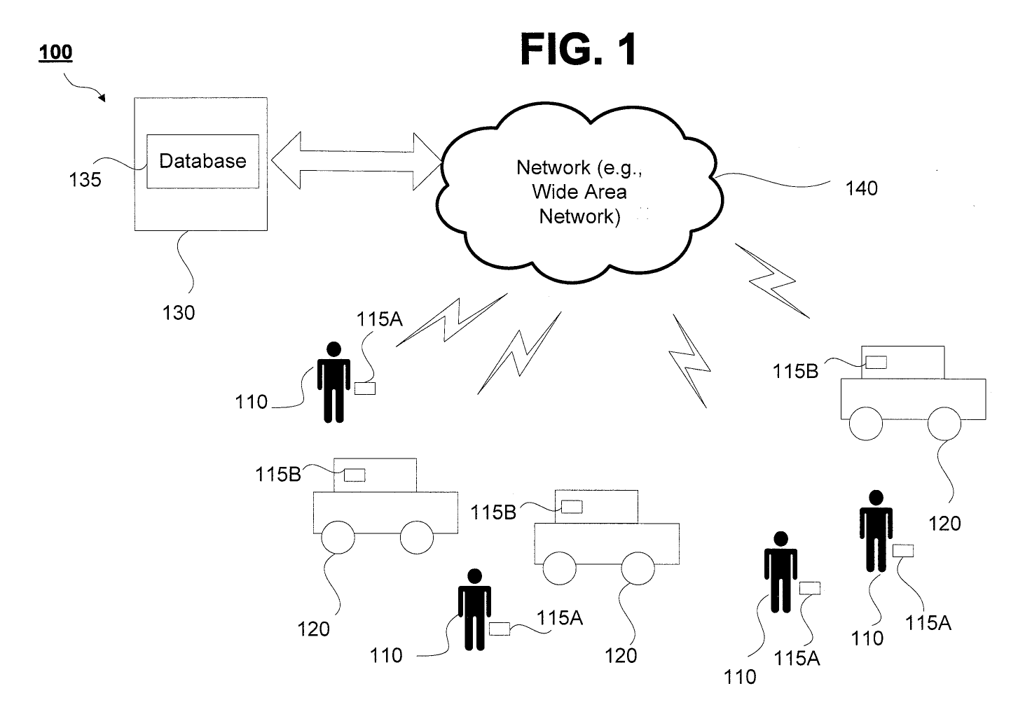

Referring now to the drawings in which like numerals represent the same or similar elements and initially to FIG. 1, an overview of a taxi dispatch system 100 is illustratively depicted in accordance with the present principles. A plurality of customers 110 and taxis 120 are in signal communication with a network 140 (e.g., a wide area network, Internet, etc.). The customers 100 and taxis 120 may communicate with the network 140 through a wired or wireless connection. However, in preferred embodiments, both the customers 110 and taxis 120 communicate wirelessly with the network 140 using mobile devices 115A and 115B (e.g., cell phone, personal digital assistant, laptop, etc.) as illustrated in FIG. 1.

Customers 110 and taxis 120 can communicate with server 130 via the network 140. Both customers 110 and taxis 120 run a local application on a device (e.g., mobile devices 115A and 115B) which is in communication with the server 130. The local applications provide interfaces which permit the customers 110 and taxis 120 to access data stored on the server 130, e.g., stored in database 135. In one embodiment, the database 135 stored on the server is implemented in MySQL, the interfaces are implemented in PHP, responses from the server 130 are provided in extensible markup language (XML), and the local applications use simple object access protocol (SOAP) calls for interactions (e.g., storage requests, retrieval requests, queries, etc.) with the server 130. However, it would be readily apparent to one of ordinary skill that the present principles may be implemented using other protocols or programming languages.

Before accessing the taxi dispatch system 100, the customers 110 and taxis 120 may submit login information (e.g., using a username and password) to the server 130. For each user, a corresponding password and username may be stored on the server 130, and this information can be used to confirm the authenticity of a user that is attempting to login. The server 130 may store other information as well. For example, for each user, the server 130 may store a number of different values including, but not limited, a user ID, user type (e.g., customer or taxi), an authentication token, etc. In addition, the server 130 may also store information which reflects the location of each user (e.g., latitude and longitude). Once logged in, the location information can be updated periodically using a global positioning system (GPS) or other known positioning system.

The server 130 may also store information for each pending travel request. For example, the server 130 may store a customer ID for each travel request which indicates the customer 110 who requested the taxi 120, a taxi ID which indicates the taxi 120 which has accepted the travel request (assuming it has been accepted), the pickup and destination addresses, the status of the request (e.g., “unaccepted”, “taken” or “complete”), etc. Moreover, although there is only a single database 135 depicted in FIG. 1, it should be recognized that the information stored on server 130 may be stored in a plurality of separate databases.

After logging in to the system, a customer 110 who wishes to request a taxi 120 may submit a “pickup address” and a “destination address” to the server 130. This may involve the customer 110 inputting the specific location where he or she is located. Alternatively, a customer 110 may select these addresses from a list of previously used addresses or a list of popular addresses (e.g., addresses of landmarks or tourist areas). Based on the address information provided by the customer 110, the server 130 may send a list of taxis 120 in the nearby area to the customer 110.

The customer 110 may then send a “travel request” to one or more of the taxis included in the list. Once the travel request has been submitted, the server 130 generates a “request ID” for the travel request and forwards the request ID to the customer 110. The request ID permits users to query a server for details about the travel request. For example, the customer 110 may periodically request the status of the travel request from the server 130 using the request ID (e.g., every five seconds). In one embodiment, the status of the request can be one of six options: “open” if a taxi has not yet confirmed the request, “taken”, “scheduled” or “picked up” if a taxi has accepted the request but the request is not yet complete, “closed” if the taxi has completed the travel request and dropped the customer at the appropriate destination location, and “cancelled” if the customer has cancelled the request.

Once a taxi 120 has accepted the customer's 110 travel request, the taxi 120 and customer 110 may exchange information (e.g., may exchange taxi ID and customer ID). Using the exchanged information, both parties can determine the location of each other, e.g., by querying the server 130 for location information associated with a taxi ID or customer ID. The location information may represent latitude and longitude coordinates, global positioning system coordinates, or any other information which can identify the location of a user. In preferred embodiments, an interactive street map is provided to one or both parties which displays the location of the respective parties on the map. Mobile devices 115A and 115B periodically provide updated location information to the server 130 (e.g., once every minute), and this updated information may be used to update the map and to track each other. After the travel request has been accepted by the taxi, the customer can view the location of the taxi, the customer's own current location, and the destination of the request on a map.

In the case where either the customer 110 or taxi 120 exits from the taxi dispatch application or becomes disconnected from server 130 without logging out, the user's information (e.g., user ID, user type, authentication token, etc.) may be stored along with the information about any pending travel requests with which the user is involved. When the user subsequently logs in or reestablishes a connection, the user may resume the pending travel request.

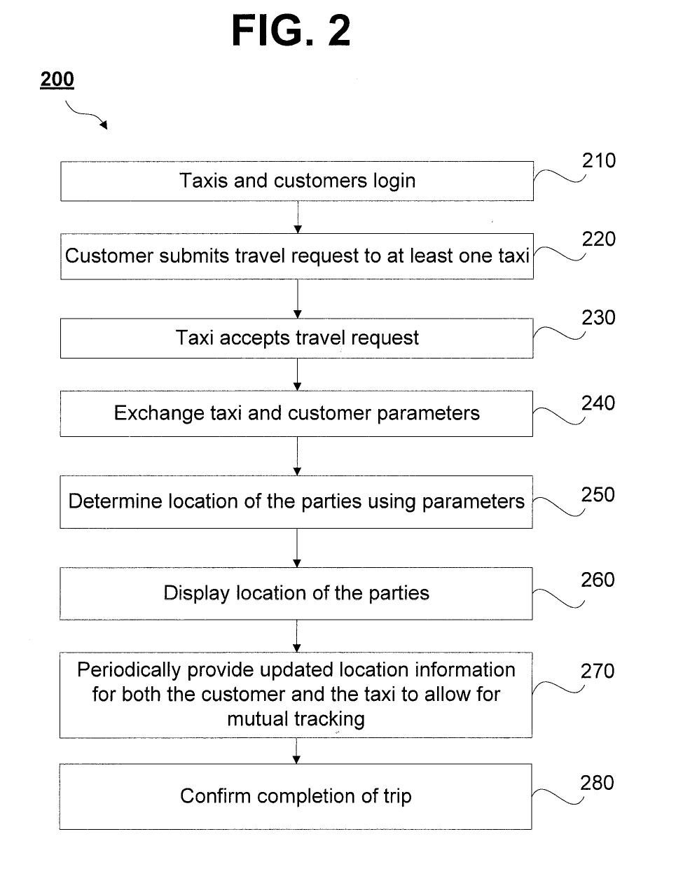

Referring now to FIG. 2, an exemplary method 200 for providing a taxi dispatch service is illustratively depicted. The method begins where customers 110 and taxis 120 login to the taxi dispatching system or application (step 210). This may require a customer 110 or taxi to enter login information (e.g., username and password). However, login information may not be necessary if a set of previously utilized user defaults can be loaded.

Once logged in, at least one of the customers 110 submits a travel request to the server (step 220). Submitting a travel request may initially involve generating a list of available taxis 120 which are in the vicinity of a pickup address entered by the customer 110 or which are in the vicinity of the customer's location (as determined by location information associated with the customer), and allowing the customer 110 to view the details of the individual taxis 120. In preferred embodiments, a list is generated by the server 130 which comprises a predetermined number of available taxis 120 that are closest to the pickup address (e.g., a list of the five closest taxis which are not servicing other customers).

Although the manner of selecting the taxis that are to receive a travel request may differ, once the request is submitted by the customer 110, a request ID is assigned to the travel request and the status of the travel request is initially set to “open”.

Next, in step 230, one of the identified taxis 120 accepts the travel request. Accepting the travel request may involve clicking an “Accept” button on an application which is running on the taxi's mobile device 115B. When one of the taxies has accepted a travel request, the status of the travel request may be changed from “open” to “taken” or “scheduled” and a taxi ID, or other information which identifies the taxi 120, may be associated with the travel request. After the travel request is accepted, the taxi 120 and the customer 110 exchange parameters either directly or by obtaining information from the server 130 (step 240). The customer 110 may obtain information about the taxi 120 such as taxi ID, taxi username, taxi location information, whether the taxi must complete other travel requests before picking up the customer, etc. Likewise, the taxi 120 may obtain information about customer 110 such as customer ID, customer username, customer location information, pickup and destination addresses, time of pickup, how many people are being picked up, etc.

All previous trips are recorded in the customer's history. The customer 110 may access the stored history at a later time, and select destinations and/or pickup addresses which have already been used for previous trips. This saves the customer 110 time and energy associated with looking up previously used pickup and destination addresses, and re-typing these addresses each time the customer 110 wishes to submit a travel request.

Regardless of which parameters are actually exchanged by the taxi 120 and the customer 110, both parties should be able to use the parameters to determine the location of each other (step 250). In one embodiment, the actual location of the parties is provided in the parameters exchanged in step 240. In another embodiment, the taxi ID, customer ID or other parameter is used to query the server 130 for the location of a party.

In step 260, the respective location of the parties is displayed to each other. For example, both the taxi 120 and the customer 110 may be provided with an interactive map on devices 115A and 115B which displays the location of the parties with respect to each other. However, displaying the location of the parties is not limited to displaying the location of the parties on a map. For example, displaying the location may simply involve displaying the latitude and longitude coordinates for both the customer 110 and the taxi, or displaying the distance between the two parties. Alternatively, displaying the location may involve displaying the name of the street and/or cross-street where a party is located.

Both the customer 110 and the taxi 120 periodically update their location information (step 270). Applications running on mobile devices 115A and 115B may determine updated locations and provide this information. This may involve sending location information (e.g., latitude/longitude information, global positioning system coordinates, etc.) at predetermined time intervals (e.g., every minute) to the server 130 or other party. This allows the taxi 120 and customer 110 to track each others' location throughout the pendency of a travel request. The updated location information can be used to update a map, or other display, which is provided to the parties.

Once the travel request has been completed and the customer 110 has been dropped off, the trip is over. At this point, a confirmation is sent to the server 130 confirming that the travel request is complete (step 280). This may also involve updating the status of the travel request from “taken” to “closed”. In preferred embodiments, it is the taxi 120 that confirms the completion of the trip.

The application will also notify the taxi 120 if it fails to pick up the customer 110 within a certain period, based on the customer's request time. The notifications will ask the taxi 120 if and when the pickup will occur. If the taxi 120 says the pickup will not occur, the taxi 120 has the option to release the customer 110 from the request, allowing another taxi 120 to accept the customer's request.

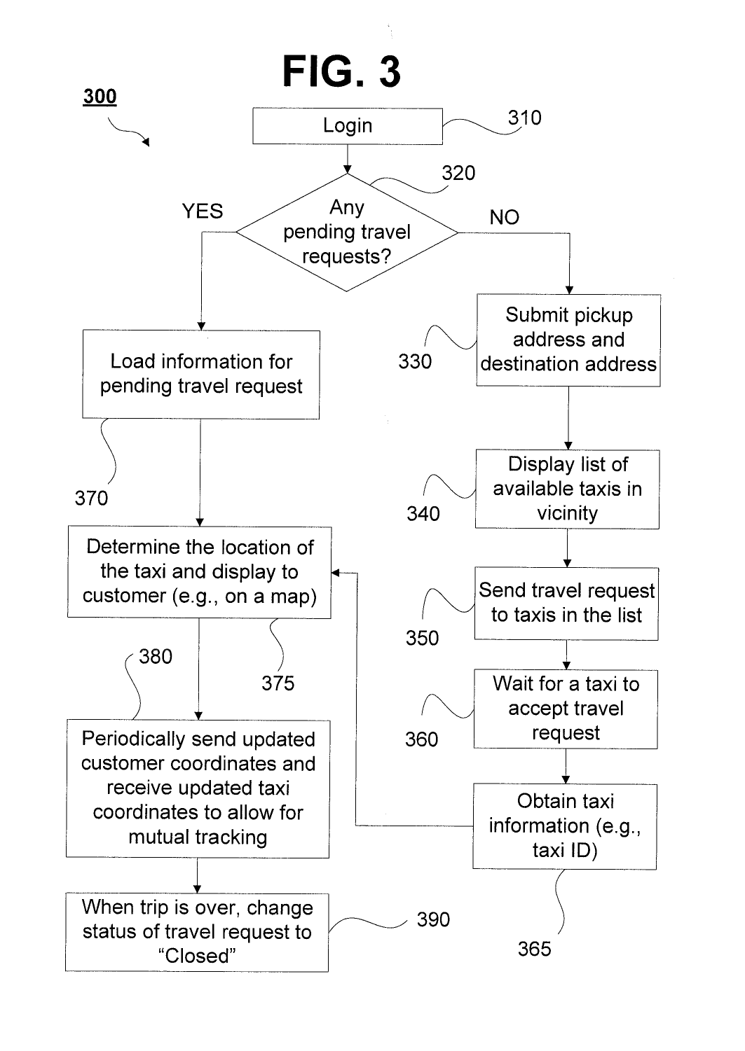

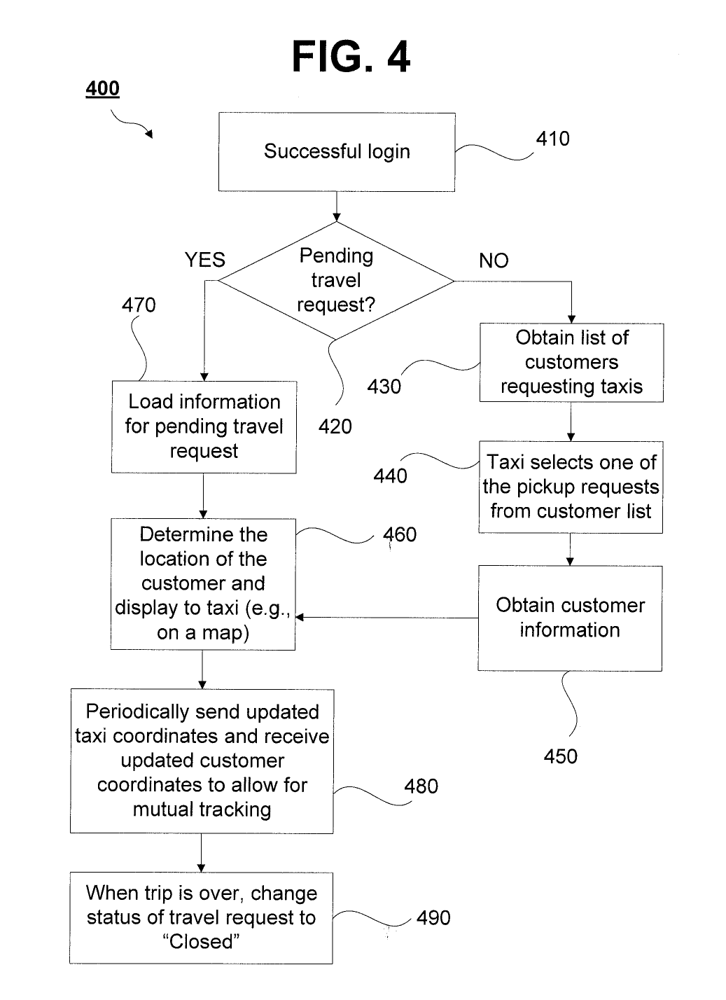

As mentioned above, the customers 110 and taxis 120 may each be equipped with mobile devices 115A and 115B, or other types of communication devices, and these devices may run applications which are in communication with a server 130 to provide the taxi dispatching scheme described herein. However, the particular applications provided to the customer 110 and taxi 120 may differ from each other. FIGS. 3 and 4 disclose exemplary methods for implementing the applications for both the customer 110 and the taxi 120.

Referring now to FIG. 3, a block/flow diagram illustrates an exemplary method 300 for providing a taxi dispatch service to a customer 110. The method begins at the start block and proceeds to step 310, where a customer 110 submits login information (e.g., such as a username and password) to a server 130 over a network 140. Default login information which was previously used by a customer 110 may be stored and loaded when logging in. Any known method for providing a secure user login may be utilized in step 310. For example, the server 130 can verify the authenticity of the customer 110 by checking that the submitted login information matches corresponding login information stored on the server 130 for that customer 110.

In preferred embodiments, the server 130 responds to a login query by returning a message to the user which includes four parameters: user ID, result (which indicates whether the login attempt was successful), user type (which indicates whether the user is a customer or taxi), and authToken. The authToken parameter stores an authentication token that can be periodically sent to the server (e.g., every five minutes) to ensure that only one user is logged into the system under a given username. Hence, if a customer 110 or taxi 120 attempts to login into the system using a username which is already logged in, the system will automatically log out from the previous device and allow the login on the current device.

After the customer 110 has successfully logged in, a determination is made as to whether the customer 110 is already associated with a pending travel request (step 320). The customer 110 may be associated with a pending travel request if the customer 110 had previously exited the taxi dispatch,application before completion of a travel request, if the customer 110 was inadvertently disconnected from the server 130 while a travel request was still pending, or for other similar reasons.

If it is determined that there are no pending travel requests associated with the customer 110 (at step 320), the customer 110 is prompted to submit a pickup address and destination address for a new request (step 330). Once this information has been submitted, the customer 110 is provided with a list of taxis 120 in the vicinity of the pickup address (step 340). This may involve the server 130 performing a search for available taxis 120 within a certain area. In preferred embodiments, the list comprises a predetermined number of available taxis 120 that are closest to the pickup address (e.g., a list of the five closest taxis which are not servicing other customers).

The customer 110 then sends a travel request to at least one of the taxis 120 in the list (step 350). Upon submission of the travel request, the travel request is associated with a request ID and the request ID is provided to the customer 110. After the request has been sent, the customer 110 waits for one of the taxis to accept the travel request in step 360. This may involve periodically requesting the status of the travel request (e.g., whether the request is “unaccepted” or “taken”) from the server 130 until one of the taxis 120 has confirmed the travel request.

Once it is determined that a taxi 120 has confirmed the travel request (e.g., once it is determined that the status of the travel request has changed to “taken”), the information for the taxi 120 (e.g., taxi ID or taxi username) is provided to the customer 110 in step 365. The customer 110 will receive notification that the request was accepted.

The taxi information may be obtained by the customer 110 in a number of different ways. For example, the taxi information may automatically be sent to the customer 110 when a taxi accepts a travel request, or customer 110 may query the server 130 for the taxi ID which associated with a particular travel request.

Next, in step 375, the location of the taxi 120 is determined and displayed to the customer (e.g., by displaying the location of the taxi on a map). This may also be accomplished in a number of ways. For example, in one embodiment, the customer 110 may request the location of the taxi 120 using the taxi information which was provided in step 365. In another embodiment, the location of the taxi 120 is automatically sent to the customer 110 with the taxi information in step 365.

In step 380, the customer 110 periodically sends updated coordinates to the server 130 which reflects the current location of the customer 110. This allows the taxi 120 to track the customer's location. The customer 110 also periodically obtains an updated location of the taxi 120 from the server 130 (e.g., by requesting the location information associated with a particular taxi ID stored on the server 130). A map, or other display provided to the customer, may be updated with the current positions of both the customer 110 and the taxi 120. The map will also provide a direct route for the taxi to get to the customer's location or pickup location if necessary. Once the customer has been picked up, the map will show the most direct route to the destination. This will allow the customer to track the routes being taken by the taxi, and will provide the customer with the necessary information to determine whether the taxi is taking an unnecessarily long route in order to overcharge the customer 110.

Once the customer has arrived at the destination address, the trip ends and the status of the travel request is updated (e.g., from “picked up” to “closed”) in step 390.

In the alternative case where it is determined that a pending travel request exists at step 320, the method proceeds to step 370 where the information for the pending travel request is retrieved by the customer 110 from the server 130. This information may include the taxi ID for the request, the request ID, the pickup and destination addresses for the request, etc. The method then proceeds from step 375 to step 390 in the same manner explained above.

In preferred embodiments, the application running on a customer's device 115A includes a “Take Me Home” feature which automates several of the steps described above with reference to FIG. 3. To take advantage of this feature, a customer 110 initially stores the location of his or her home address in device 115A or at server 130. Rather than having to submit a pickup and destination address (e.g., as in step 330), the customer 110 can simply select a “Take Me Home” button after the user has logged in.

Upon selecting this feature, a series of actions automatically take place. First, the customer's device 115A automatically submits a pickup address, a destination address and a pickup time to the server 130. Specifically, the device 115A determines the customer's current location (e.g., using GPS positioning) and uses this location as the pickup address, and then extracts the customer's home address from memory and uses this location as the destination address. The pickup time is set as the current time.

The device then automatically searches for nearby taxis or participating car services. When nearby taxis 120 are located, the taxis 120 which are closest to the current location of the customer 110 are first displayed. At this point, the customer 110 can just press the request button to hail a taxi 120. When a cab accepts the customer's request, the customer device 115A indicates that a cab is on its way and provides the taxi's information, distance and the approximate time that the taxi 120 will reach the pickup location.

Referring now to FIG. 4, a block/flow diagram illustrates an exemplary method 400 for providing a taxi dispatch service to a taxi. In step 410, the taxi or taxi driver 120 first logs in to the taxi dispatch system. This can be done in the same manner discussed above with respect to the customer 110, e.g., by entering a username and password.

Once the taxi 120 is logged in, a determination is made as to whether the taxi 120 has already accepted a pending travel request (step 420). The taxi 120 may be associated with a pending travel request if the taxi 120 had previously exited the taxi dispatch application before completion of a travel request, or if the taxi 120 was inadvertently disconnected from the server 130 while a travel request was still pending.

If it is determined that there are no pending travel requests for the taxi 120, the method proceeds to step 430 where the taxi 120 obtains a list of travel requests or customers requesting taxis. In one embodiment, the list includes all requests which have been submitted to the particular taxi 120 by a customer (e.g., as above in step 350). In another embodiment, only a predetermined number of customers 110 who have entered a pickup address within a predefined distance of the taxi's location are included in the list.

Next, in step 440, the taxi 120 selects one the of the travel requests from the customer list. Upon accepting a travel request, the status of the request is changed from “open” to “taken”. The taxi 120 may also be associated with a status which represents whether or not the taxi 120 is available to pickup customers. For example, when a taxi 120 has accepted a travel request, the status of the taxi 120 may change from “available” to “taken”. By checking the status of the taxi 120, the taxi 120 may be excluded from a list of available taxis which is presented to customers (e.g., as discussed above with respect to step 340 of FIG. 3). However, the taxi 120 will be visible to customers who have already requested a trip with that taxi.

After the taxi 120 has accepted a travel request, the taxi 120 obtains information about the customer 110 stored on the server 130 in step 450. The customer information obtained by the taxi 120 may include the customer ID, request ID, request details, location information for the customer, etc. Using this information, the taxi 120 can determine the location of the customer 110 (step 460). The manner in which the customer's location is determined may differ. For example, in one embodiment, the taxi 120 may request the location of the customer 110 using a customer ID or request ID which was provided in step 450. In another embodiment, the location of the customer 110 is automatically sent to the taxi 120 with the taxi information in step 450. Regardless of how the location of the customer 110 is determined, a map or other display may be provided to the taxi 120 which shows the location of the customer 110 with respect to the taxi 120 location.

In step 480, the taxi's mobile device 115B periodically sends updated coordinates (or other type of location information) to the server 130 so that the customer 110 can track the location of the taxi 120. The taxi also checks the server 130 for updated location information for the customer 110. The updated location information for both the taxi 120 and the customer 110 allows for mutual tracking capabilities, and may be used to update the map or other display which is provided to the taxi 120.

The map displays the most direct route from the taxi's 120 current location to the customer's location and/or the pickup address which was specified by the customer 110 in the request. Once the customer 110 has been picked up, the map may be used as a navigational aid by displaying the most direct route to the destination. The map can be updated to account for necessary diversions from the planned route.

The method ends in step 490 when the taxi 120 has dropped off the customer 110 at the destination address and completed the travel request. At this point, the status of the travel request should be change from “picked up” to “closed”.

However, in the case where it is determined that a taxi 120 is associated with a pending travel request (at step 420) after logging in, the method proceeds to step 470 where the information from the pending travel request is provided to the taxi 120. The information provided to the taxi 120 may include the customer ID, the pickup and destination addresses, the request ID, etc. The method then displays all accepted requests to the taxi 120, who then has the option to select one of the requests.

Having described preferred embodiments of a system and method for dispatching taxis (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for dispatching taxis, comprising:
sending a list of taxis to a customer;
selecting at least one taxi from the list that is to receive a travel request;
providing a display which indicates a location of the customer and a location of a taxi which has accepted the travel request; and
updating location information of the customer and taxi during pendency of the accepted travel request.

2. The method of claim 1, further comprising updating the location of the customer and the location of the taxi on the display using the updated location information.

3. The method of claim 1, further comprising initially determining whether a travel request from a previous session is pending for a user.

4. The method of claim 1, further comprising entering a pickup address for the customer, wherein the list sent to the customer comprises a predetermined number of available taxis which are closest in proximity to the pickup address.

5. The method of claim 1, wherein the list comprises a predetermined number of available taxis which are closest in proximity to a pickup address which has been submitted by the customer.

6. The method of claim 1, wherein a request ID is assigned to the travel request to permit users to query a server for details about the travel request.

7. The method of claim 1, wherein providing a display involves providing an interactive map which indicates the location of the both the customer and the taxi.

8. The method of claim 1, further comprising providing taxis with a list of travel requests which have been submitted by customers.

9. A computer program product comprising a computer readable storage medium having a computer readable program, wherein the computer readable program when executed on a computer causes the computer to perform the steps of:
sending a list of taxis to a customer;
selecting at least one taxi from the list that is to receive a travel request;
providing a display which indicates a location of the customer and a location of a taxi which has accepted the travel request; and
updating location information of the customer and taxi during pendency of the accepted travel request.

10. The computer program product of claim 8, further comprising updating the location of the customer and the location of the taxi on the display using the updated location information.

11. The computer program product of claim 8, further comprising initially determining whether a travel request from a previous session is pending for a user.

12. The computer program product of claim 8, further comprising entering a pickup address for the customer, wherein the list sent to the customer comprises a predetermined number of available taxis which are closest in proximity to the pickup address.

13. The computer program product of claim 8, wherein a request ID is assigned to the travel request to permit users to query a server for details about the travel request.

14. The computer program product of claim 8, wherein providing a display involves providing an interactive map which indicates the location of the both the customer and the taxi.

15. The computer program product of claim 8, further comprising providing taxis with a list of travel requests which have been submitted by customers.

16. A system for dispatching taxis, comprising:
a communication device configured to receive a list of taxis and to permit the selection of at least one taxi in the list that is to receive a travel request;
a display which indicates a location of a customer and a location of a taxi which has accepted the travel request; and
a server configured to receive updated location information for determining updated locations for the customer and taxi.

17. The system of claim 15, wherein the updated location information is used to update the location of the customer and the location of the taxi on the display.

18. The system of claim 15, wherein the system initially makes a determination as to whether a travel request from a previous session is pending for a user.

19. The system of claim 15, wherein the list comprises a predetermined number of available taxis which are closest in proximity to a pickup address which has been submitted by the customer.

20. The system of claim 15, wherein a request ID is assigned to the travel request to permit users to query a server for details about the travel request.
